(19) United States
(12) Patent Application Publication
(10) Pub. No.: US 2025/0250453 A1
(43) Pub. Date: Aug. 7, 2025

(54) Systems, Devices, and Methods for Making and Using Printable Copper-Based Metal and Intermetallic Ink Materials

(71) Applicant: University of Maryland, College Park, College Park, MD (US)

(72) Inventors: Shenqiang Ren, College Park, MD (US); Abdullah Islam, Buffalo, NY (US)

(21) Appl. No.: 19/044,548

(22) Filed: Feb. 3, 2025

Related U.S. Application Data
(60) Provisional application No. 63/549,440, filed on Feb. 2, 2024.

(51) Int. Cl. C09D 11/52; C09D 11/037; H01B 1/22

(52) U.S. Cl. CPC C09D 11/52; C09D 11/037; H01B 1/22

(57) ABSTRACT

This present disclosure is directed to systems, devices, and methods of making printable copper and its alloy ink materials for materials such as printable electronics.

### CROSS REFERENCE TO RELATED APPLICATIONS

This application claims priority to U.S. Application No. 63/549,440, filed on Feb. 2, 2024, the contents of which are hereby incorporated by reference in its entirety.

### STATEMENT OF FEDERALLY SPONSORED RESEARCH AND DEVELOPMENT

This invention was made with government support under W911NF-19-2-0011 awarded by the Army Research Laboratory-Army Research Office. The government has certain rights in the invention.

### FIELD OF THE INVENTION

The field of the invention relates generally to systems, devices, and methods of making printable copper and its alloy ink materials for printable electronics.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

In an age of rapid globalization, sustainable methods for effective communication and networking have become an absolute necessity for everyday life. In particular, the increasing development of radio frequency devices with both short- and long-range communication capabilities are ever more important. Similarly, on a larger scale, aviation applications for RF based navigation and wireless communications systems have also seen a greater need for technical development. Effective RF devices that can consistently communicate along a frequency channel with minimal losses go hand in hand with manufacturing techniques which can not only be cost effective and sustainable but can also reliably form high quality thin film conductors. Present day methods include a variety of subtractive techniques which are often costly and necessitate the use of many toxic chemicals and waste. A transition to conductive inks with large scale additive manufacturing methods points to a path for highly functional electronics with minimal waste.

Conventional additive manufacturing techniques include inkjet, aerosol jet, and extrusion-based printing. Contemporary research has demonstrated varying success in the use of conductive inks with these methods. These inks include metallic nanostructured inks, carbon nanoscale inks, as well as conductive polymer inks. Metallic inks consistently show a greater viability for printable electronics due to their relatively higher electrical conductivity. This leaves copper as a sustainable alternative. Despite this, there are some inherent challenges to using copper nanostructured inks for ambient condition oxidation as compared to a copper precursor-based ink. Similarly, they often require the use of additives which can increase the initial sintering conditions for high electrical conductivity. Therefore, the combination of additive manufacturing techniques using a copper precursor-based ink can prove more effective for the manufacturing of electronic devices.

Thus, there remains a need for printable metallic conductors with a high level of mechanical and thermal stability for additive manufacturing of radiofrequency electronics.

### SUMMARY

One aspect of the invention pertains to a metallic MOD in composition, said composition comprising a transition metal-formate salt. Another aspect of the invention A method of making a metallic MOD ink composition of any of the proceeding embodiments, said method comprising mixing di-ethylene glycol butyl ether (DEGBE) or benzoyl alcohol, dimethylformamide (DMF) or ethylene glycol, and a transition metal-formate salt to form a mixture, wherein said mixture is processed into small particles to make an ink. Another aspect of the invention pertains to A coated material, said material comprising an ink of any of the preceding embodiments disposed on at least a portion of a surface of said material.

### BRIEF DESCRIPTION OF THE FIGURES

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1. FIG. 1a. Schematic printing of CuMOD ink on polyimide substrate followed by hot press application for creating a uniform copper film. FIG. 1b. Free standing film annealed at high temperature followed by substrate transfer and fine-featured laser ablation. FIG. 1c. Laser ablation of CuMOD sheet. Demonstration of solderability using silver paste to solder an LED resistor to a CuMOD printed electrode. FIG. 1c. Ashby plot comparing electrical conductivity across different conductive materials used in flexible electronics (carbon, CNTs, Graphene, AuNPs, AuNWs, AgNPs, AgNW, CuNPs, CuNPLs, CuG, CuMOD, EGain, Bi₃₅In_{48.6}Sn₁₆Zn_{0.4}, Ga_{68.5}In_{21.5}Sn₁₀, PEDOT:PSS, Polyaniline).

FIG. 2. SEM imagery of CuMOD prints FIG. 2a. unsintered, sintered at FIG. 2b. 250° C., and sintered at FIG. 2c. 900° C. FIG. 2d. XRD analysis of films sintered across a range 400-800° C. Cross sectional SEM of copper films with varied thicknesses, FIG. 2e. 250 nm, FIG. 2f. 1 μm, FIG. 2g. 3 μm, FIG. 2h. 9 μm.

FIG. 3. FIG. 3a. Temperature and time dependent sheet resistance values of samples sintered across a range of 213-250° C. from 1-5 minutes FIG. 3b. Respective sheet resistance values as electrode thickness is varied. FIG. 3c. S11 and S21 response of antennae with varied print thickness. FIG. 3d. EMI shielding effectiveness at different sample thicknesses.

FIG. 4. FIG. 4a. Electrical conductivity as compared to annealing temperature of copper films. FIG. 4b. EMI shielding of thin films sintered at different temperatures. FIG. 4c. Image of physical dipole antennas on PET. Kapton®, glass and paper. FIG. 4d. RF response of multi substrate dipole antennas.

FIG. 5. FIG. 5a. The resistance of a copper electrode as held at 150° C. for 12 hours and then cooled. FIG. 5b. Demonstration of continuous bending cycles for 10 minutes of samples with varied width. FIG. 5c. Schematic depiction of bend test apparatus.

FIG. 6. Hot press set up for sintering CuMOD ink on polyimide substrate.

FIG. 7. XRD data of copper films sintered at 213° C. and 250° C. Characteristic peaks at (111), (200) and (220) are visible.

Particular non-limiting embodiments of the present invention will now be described with reference to accompanying drawings.

### DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “degradable polymeric product” refers to a polymeric product that degrades in the presence of peroxide (e.g., hydrogen peroxide).

The term “molecular ink” refers to a conductive ink used for printing electronics that's made from ionic molecules.

The term “CuMOD inks” refers to copper-organic decomposition inks.

The term “S-parameter” refers to the response of the copper electrode antennae at different applied frequencies.

The term “metallic MOD ink composition” as used herein refers to a metal-organic decomposition (MOD) ink comprising a transition metal-formate salt dissolved in one or more solvents (e.g., an polar or non-polar solvent such as di-ethylene glycol butyl ether (DEGBE) or benzoyl alcohol, dimethylformamide (DMF) and/or ethylene glycol, which upon thermal treatment decomposes to form a conductive metallic layer. In some embodiments, metallic MOD composition comprises a copper formate salt and/or nickel formate salt in solution.

One aspect of the invention pertains to a metallic MOD composition, said composition comprising a transition metal-formate salt. In some embodiments, said transition metal has a reduction potential of about −0.30 V to about +1.20 V. In some embodiments, said transition metal is copper, nickel, silver, platinum, or palladium. In some embodiments, said transition metal is an alloy such as a copper alloy, for example, a copper nickel alloy.

In some embodiments, said transition metal is copper wherein said copper has a net charge of +2, and said transition metal-formate salt is copper (II) formate.

In some embodiments, the sintering temperature of said composition is about 230° C. to about 1100° C.

Another aspect of the invention pertains to method of making a metallic MOD ink composition of any of the proceeding embodiments, said method comprising mixing di-ethylene glycol butyl ether (DEGBE) or benzoyl alcohol, dimethylformamide (DMF) or ethylene glycol, and a transition metal-formate salt to form a mixture, wherein said mixture is processed into small particles to make an ink, wherein said mixture is processed by into small particles by ball milling, wherein said mixture is ball milled for about 1 hour.

In some embodiments, said transition metal has a reduction potential of about −0.30 V to about +1.20 V. In some embodiments, said transition metal is copper, nickel, silver, platinum, or palladium. In some embodiments, said transition metal is an alloy such as a copper alloy, for example, a copper nickel alloy.

In some embodiments, said transition metal is copper wherein said copper has a net charge of +2, and said transition metal-formate salt is copper (II) formate.

In some embodiments, said copper (II) formate, DEGBE, and DMF are mixed in a ratio of about 4.5:about 5.0:about 0.45.

Another aspect of the invention pertains to a coated material, said material comprising an ink of any of the preceding embodiments disposed on at least a portion of a surface of said material, wherein said substrate is metal, glass, fabric, or a combination thereof.

### LIST OF EMBODIMENTS

1. A metallic MOD ink composition, said composition comprising a transition metal-formate salt. In some embodiments, said composition a transition metal-formate salt and one or more solvents.
2. The ink composition of embodiment 1, wherein said transition metal has a reduction potential of about-0.50 V to about +1.20 V.
3. The composition of embodiment 1, wherein said transition metal is an alloy (e.g., a copper alloy).
4. The composition of embodiment 3, wherein said alloy is a copper nickel alloy.
5. The composition of embodiment 1, wherein said transition metal is copper, nickel, silver, platinum or palladium.
6. The composition of embodiment 1, wherein said transition metal is copper.
7. The composition of embodiment 6, wherein said copper has a net charge of +2.
8. The composition of embodiment 1, wherein said transition metal-formate salt is copper (II) formate.
9. The composition of claim 1, wherein said ink has a sintering temperature of about 230° C. to about 1100° C.
10. A method of making a metallic MOD ink composition of any of the proceeding embodiments, said method comprising mixing di-ethylene glycol butyl ether (DEGBE) or benzoyl alcohol, dimethylformamide (DMF) or ethylene glycol, and a transition metal-formate salt to form a mixture, wherein said mixture is processed into small particles to make an ink.
11. The method of embodiment 10, wherein said mixture is processed into small particles by ball milling.
12. The method of embodiment 11, wherein said mixture is ball milled for about 1 hour.
13. The method of embodiment 10, wherein said transition metal has a reduction potential of about −0.30 V to about +1.20 V.
14. The method of embodiment 10, wherein said transition metal is alloy (such as copper alloy).
15. The method of embodiment 14, wherein said alloy is a copper nickel alloy.
16. The method of embodiment 10, wherein said transition metal is copper, nickel, silver, platinum or palladium,
17. The method of embodiment 10, wherein said transition metal is copper.
18. The method of embodiment 17, wherein said copper has a net charge of +2.
19. The method of embodiment 10, wherein said transition metal-formate salt is copper (II) formate.
20. The method of any of the preceding embodiments, wherein said copper (II) formate, DEGBE, and DMF are mixed in a ratio of about 4.5:about 5.0:about 0.45.
21. A coated material, said material comprising an ink of any of the preceding embodiments disposed on at least a portion of a surface of said material. In some embodiments, said ink is sintered to obtain a coated material comprising Cu⁰ particles. In further embodiments, said ink is sintered to obtain a coated material comprising Ni⁰ and Cu⁰ particles.
22. The material of embodiment 21, wherein said substrate is metal, glass, fabric, or a combination thereof.
23. The material of embodiment 21, wherein said ink is sintered (e.g., at a temperature in the range of about 200° C. to about 250° C., or about 213 to about 237° C.) and comprises Cu⁰ particles.
24. The material of embodiment 21, wherein said ink is sintered (e.g., at a temperature in the range of about 200° C. to about 250° C.) and comprises Ni⁰ and Cu⁰ particles.
25. A coated material, said material comprising an ink of any of the preceding embodiments disposed on at least a portion of a surface of said material, wherein said ink is prepared using any of the preceding methods.

### EXAMPLES

The following examples are provided solely to illustrate the present invention and are not intended to limit the scope of the invention, described herein.

### Example 1. Preparation of Copper Precursor Ink

Copper formate, Di-ethylene glycol butyl ether (DEGBE) and dimethylformamide (DMF) were added to a ceramic ball milling container at a ratio of 4.5:5.0:0.45 respectively. This was ball milled at 300 rpm for 1 hour. After ball milling, the respective ink was collected and centrifuged at 6000 rpm for 5 minutes. The supernatant was decanted and an additional 2 mL of DEGBE was pipetted into the slurry and the slurry was re-dispersed using a vortex mixer. This was again centrifuged as previously mentioned. This was repeated once more. After decanting the final wash, the slurry was used as is.

### Example 2. Preparation of Thin Film Copper Sheet

The copper sheets were manufactured by screen printing the slurry onto a polyimide substrate (Pyrallux® and Kapton®). The substrate with the printed square was then placed into a preheated hot press at the respective temperature as recorded before (213-250° C.) at a maximum of 5 minutes. A sheet of Kapton® or Pyrallux® was also placed on top of the substrate to reduce copper decomposition onto the mechanical components of the hot press as well as to act as an acceptor substrate for any of the excess of the primary decomposition.

### Example 3. Two-Step Fabrication of Ultra-Thin Film Dipole Antennas

The prepared copper sheets on Kapton® were submerged in a solution of sodium borohydride and lightly agitated until the copper sheeting delaminated from the polyimide substrate. This was then transferred to a petri dish with distilled water and submerged to wash away any remaining sodium borohydride residue.

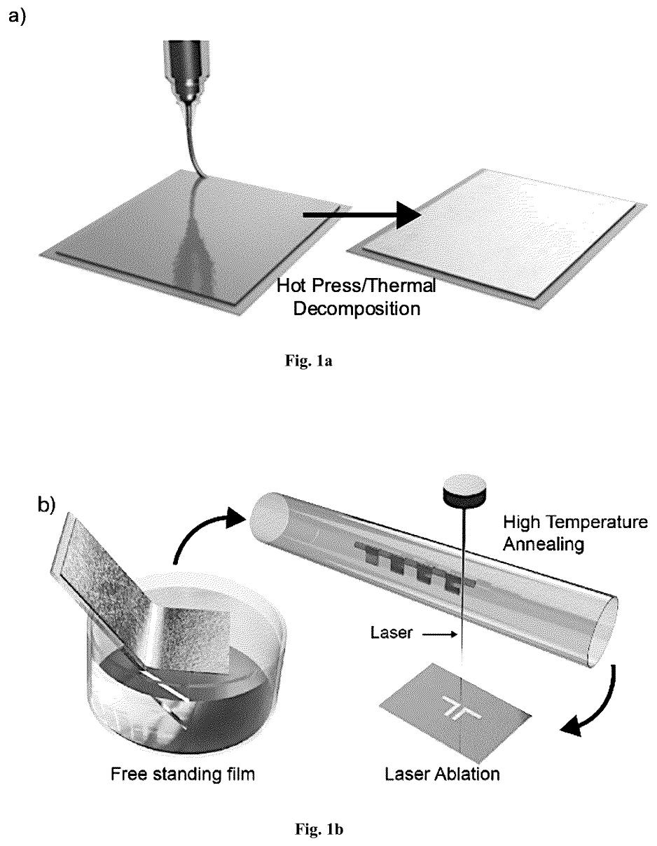

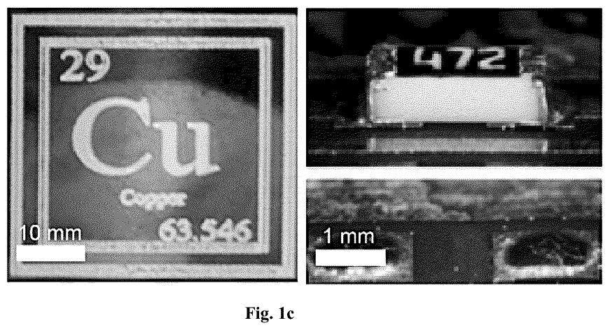

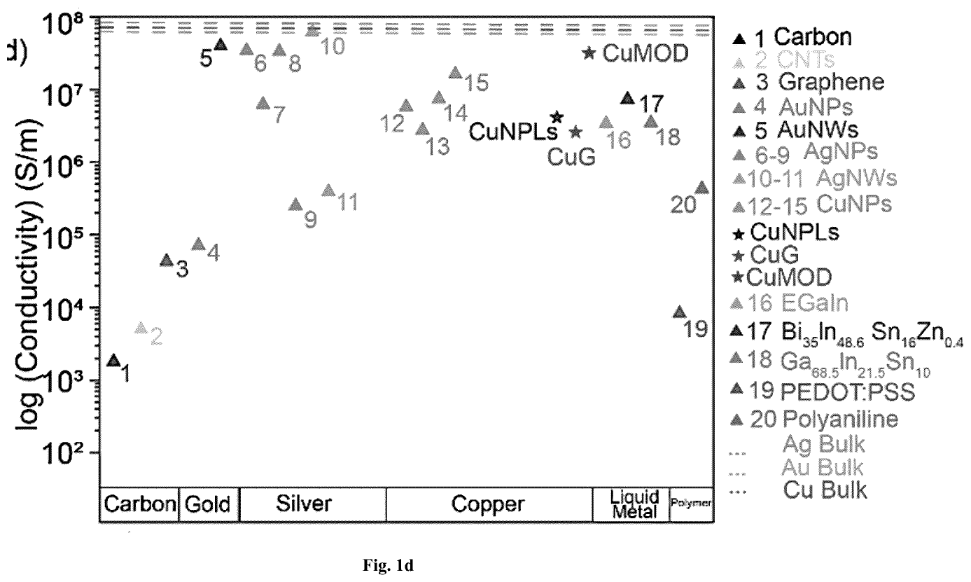

The washed film was hung on ceramic tubing and placed in a ceramic container to be sintered in a tube furnace at 900° C. (FIG. 1b). The sintering process was done under a continuous nitrogen-hydrogen mixture flow (5% Hydrogen in Nitrogen). After annealing, the samples were removed and transferred to a glass substrate for laser ablation. The transfer process from substrate to substrate only requires some slight wetting of the thin copper film and then placing it and allowing it to dry.

Samples were transferred to ceramic, glass, paper and Kapton and then laser ablated to form a dipole antenna. The wavelength frequency was adjusted to enable fine feature cutting of the substrate without any residual material ablation during the process.

### Example 4. EMI Shielding Performance Measurements

The EMI shielding performance was characterized by the Shielding Effectiveness Test Fixture (EM-2108) from Electro Metrics. The thin film samples sit within the passage shared by two probes on each end, with one probe functioning as the transmitting antenna while the other as a receiving antenna. RF waves at a specific frequency are transmitted towards the sample and the receiving antenna collects the electromagnetic signals. The EMI shielding performance is characterized by the sample's ability to block the RF noise from reaching the receiving antenna.

### Example 5. Results and Discussion

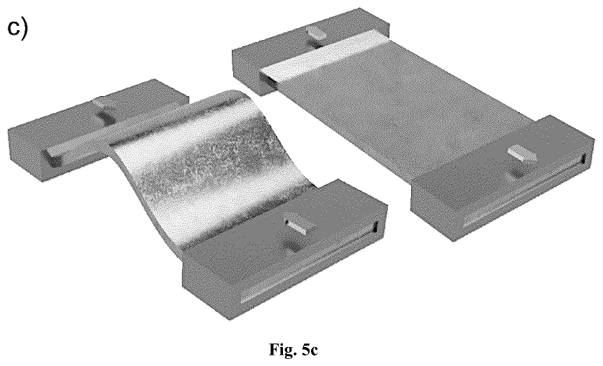

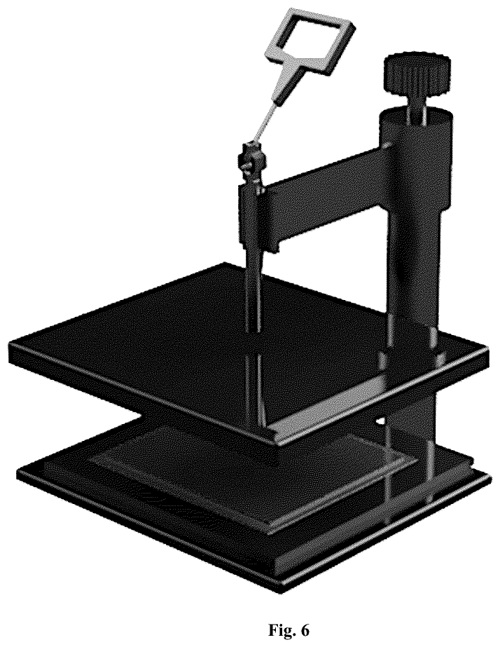

As shown in FIG. 1a, large-scale sheets of flexible copper can be synthesized by printing the copper slurry and hot pressing it above a temperature of 200° C. for up to 5 minutes (FIG. 6). Further incorporation of these electrodes may need solderability to other electronic attachments and components. FIG. 1b consequently depicts the methods for forming a free-standing film from the printed copper electrode which can then be annealed at high temperatures, transferred to a variety of substrates and laser ablated. A more detailed comparison of these sintered and high temperature annealed films is discussed further on. An image of a laser ablated sample is shown in FIG. 1c showing a fine-featured image without excessive destruction or delamination of the copper thin film. FIG. 1c shows its solderability demonstrated by the lack of pooling of the solder on the electrode surface as an LED resistor is attached between the electrodes. The Ashby plot in FIG. 1d demonstrates a comparison of this work to other conductive materials used in flexible electronics applications. The CuMOD ink printed conductor with a high conductivity of 47 MS/m is more electrically conductive than other existing copper-based materials as well as other inks made of liquid metals, carbon nanostructures and conductive polymers.

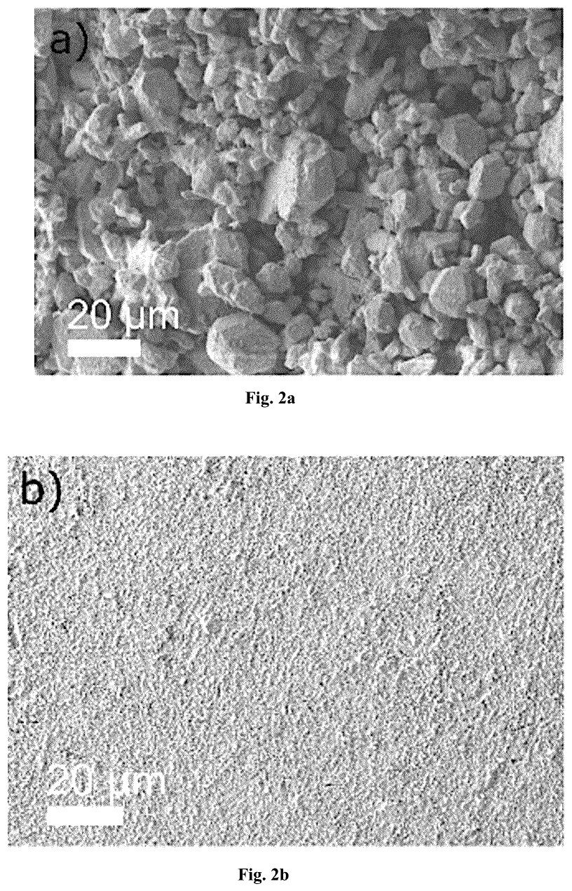

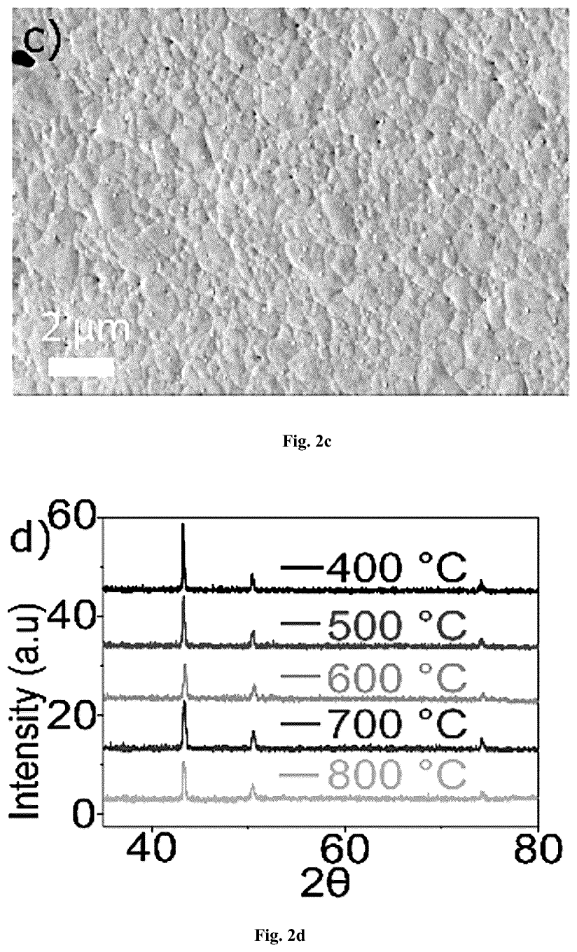

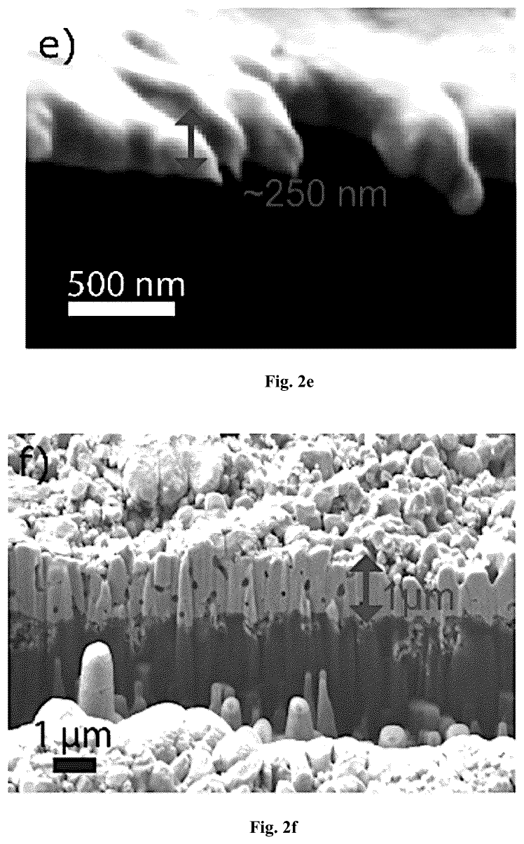

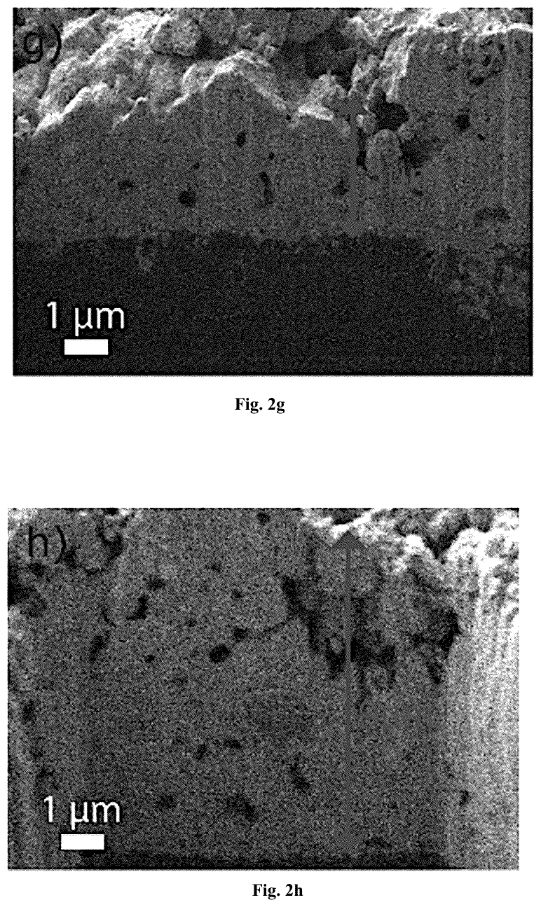

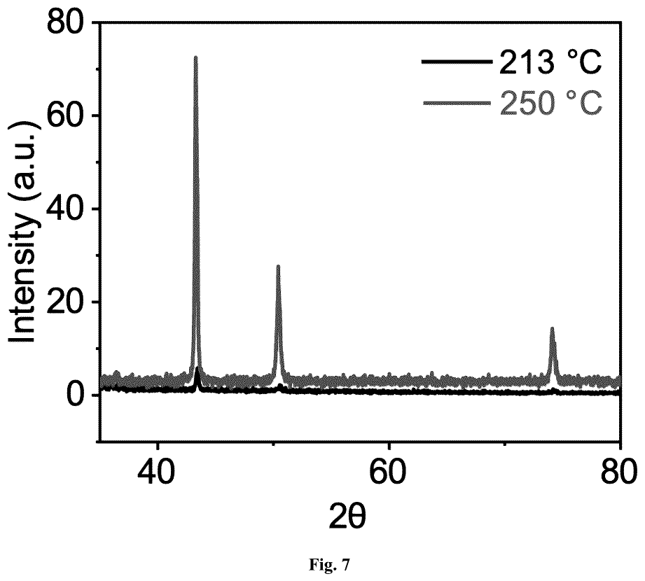

Processing conditions and sample thickness was varied to study improvements in electrical conductivity and the crystallinity and morphology of the printed conductors were further characterized by X-ray diffraction (XRD) and scanning electron microscopy (SEM). FIG. 2a-c shows a CuMOD print before sintering, after sintering at 250° C. and after post annealing at 900° C. respectively. The unsintered ink is shown to be made of micron scale particles which create a dense and well percolated nanoparticle film when sintered at 250° C. Further annealing at higher temperatures creates a more continuous film as copper particles undergo fusion. The XRD patterns of printed copper films prepared at both 213° C. and 250° C. exhibit copper characteristic diffraction peaks (111), (200) and (220) (FIG. 7). However, compared to the sample sintered at 213° C., the copper films prepared at 250° C. have a greater crystallinity. Subsequent x-ray diffraction patterns across an annealing range from 400° C. to 800° C. similarly show copper characteristic diffraction peaks (FIG. 2d) as demonstrated in literature. The improved surface morphology after high temperature annealing effectively reduces the electron scattering effect and increases the electron mobility to achieve higher electric conductivities in these printed copper films. The thickness of the sample is another factor which plays an important role in the sheet resistance of the printed copper conductors. FIG. 2e-h demonstrates this aspect with a cross-sectional SEM comparison across 250 nm, 1 μm, 3 μm and 9 μm sample showing that as thickness increases the resistance decreases. This relates again to the greater cross-sectional area in the conductor which promotes greater electron mobility. Some porosity can also be seen across the cross-section of these samples which can be related to the degassing and release of hydrogen during the decomposition of copper formate in the print. Despite this porosity, these printed electrodes still maintain very low values of sheet resistance as demonstrated later in the study.

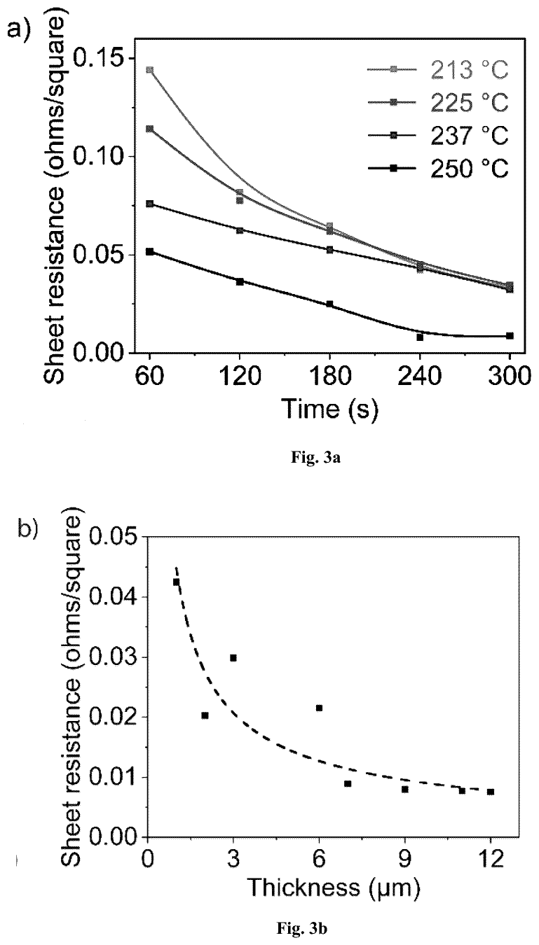

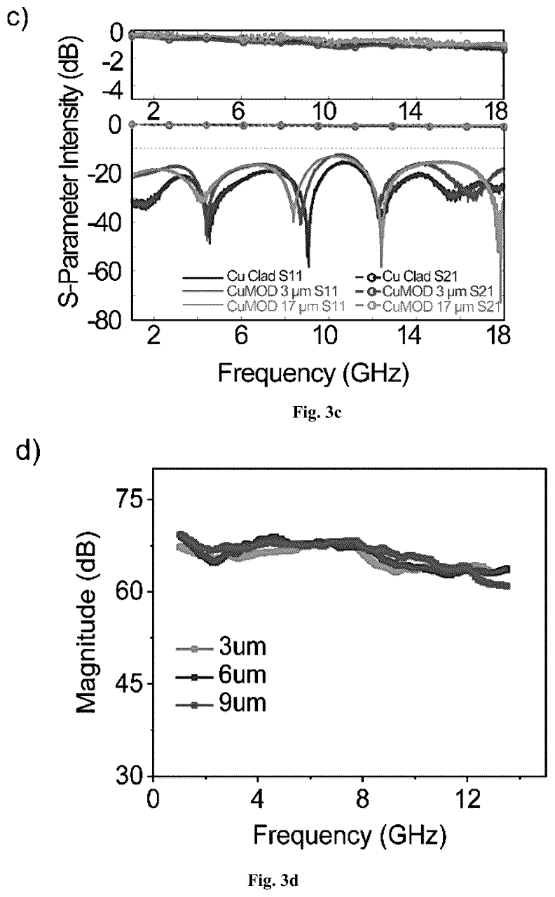

Processing conditions and sample thickness were studied to assess optimal film properties for electronic applications. As can be seen in FIG. 3a, the general trend of the data demonstrates that as temperature increases from 213° C. to 250° C. the sheet resistance of the conductors decreases from 0.144 ohms/square to 0.052 ohms/square at a sintering time of one minute. Likewise, an increased sintering time, up to 5 minutes held under the hot press, decreased the sheet resistance with values of 0.032 ohms/square and 0.0087 ohms/square at 213° C. and 250° C., respectively. The lower sheet resistance can be attributed to the faster decomposition and better percolation of the copper nanoparticles at higher temperatures. FIG. 2a shows that the recorded values of sheet resistance begin to overlap as the sintering time is increased beyond 4 minutes with temperatures from 213 to 237° C. This overlap can be attributed to the near full decomposition of the printed CuMOD ink by this time which normalizes previous deviation in the data at lower sintering times. Notably, there is nearly a 27% difference in average sheet resistance when comparing samples sintered at 250° C. and the average sheet resistance of electrodes sintered at 213-237° C. at 5 minutes. This indicates a significantly greater advantage to sintering the CuMOD ink at a higher temperature.

As an optimal sintering temperature and time is reached, slight oxidation is also a possibility.

Cu(CHOO)_{2(aq)}→Cu₍ₛ₎+2CO_{2(g)}+H_{2(g)} (1)

During the decomposition of copper formate (1), the release of hydrogen paired with the pressurized seal from the hot press creates an inert environment such that excessive oxidation is not experienced. This is more apparent at a sintering temperature of 250° C. as it reaches an optimal sintering time at 3 minutes (0.0073 ohms/square) and experiences a slight increase in sheet resistance as it is held till 5 minutes (0.0087 ohms/square)-likely due to potential surface oxidation of the sample. A study of variable film thickness in FIG. 3b, also shows that the sheet resistance decreases from a 1-micron thick sample with a sheet resistance of 0.043 ohms/square to a sheet resistance of 0.0075 ohms/square on a 12-micron thick sample (FIG. 3b). The greater cross-sectional pathway introduces a means for achieving favorably lower sheet resistance values. FIG. 3c shows the RF performance of commercially available copper clad material (CuClad), and CuMOD derived copper films. These plots compare the S11 and S21 parameters of the RF antennae across a broad range frequency. The S-parameters are used to show the response of the copper electrode antennae at different applied frequencies. The S11 data in FIG. 3a does not show significant peak shifts compared with the CuMOD and the CuClad material. The operational bandwidth frequencies across the S11 signal are from 4-8, 8-12, and 12-16 GHz. Towards the end of the assessed frequency range, a slight broadening of the CuMOD signal can be detected at a frequency of 16 GHz and beyond, and this can potentially be due to losses because of external RF interference. Thickness variation from 3-microns to 17-microns also does not show a significant effect on the resonant frequencies across the S11 signal. The S21 parameters of CuMOD and CuClad nearly overlap and as frequency increases, they tend to have the same trend in intensity loss. This indicates the strong reliability of the CuMOD derived conductors to act as an effective RF device across a broad range frequency (0-18 GHz) without having any significant power losses. FIG. 3d demonstrates applications of this material for electromagnetic interference shielding applications with variable samples thickness of 3-, 6- and 9-microns. An increase in EMI shielding would have been expected as the sample thickness increased due to increased irradiation of the signal, however samples with thicknesses of 3-, 6- and 9-microns all produced a close average of 65 dB across the frequency range (1-13 GHZ). Previous sample porosity of the cross-sectional area of the films as seen in FIG. 2e-h provides a potential explanation as to why there is very little significant EMI variation across the thickness range.

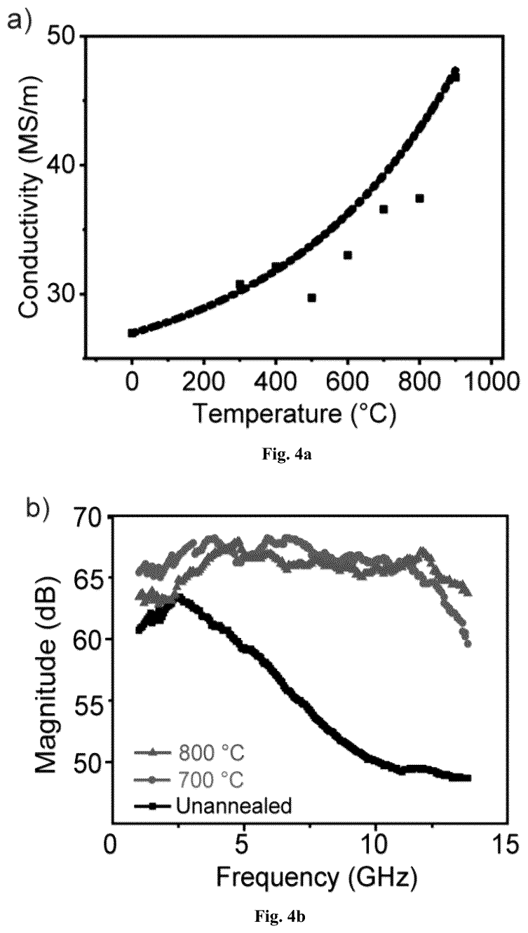

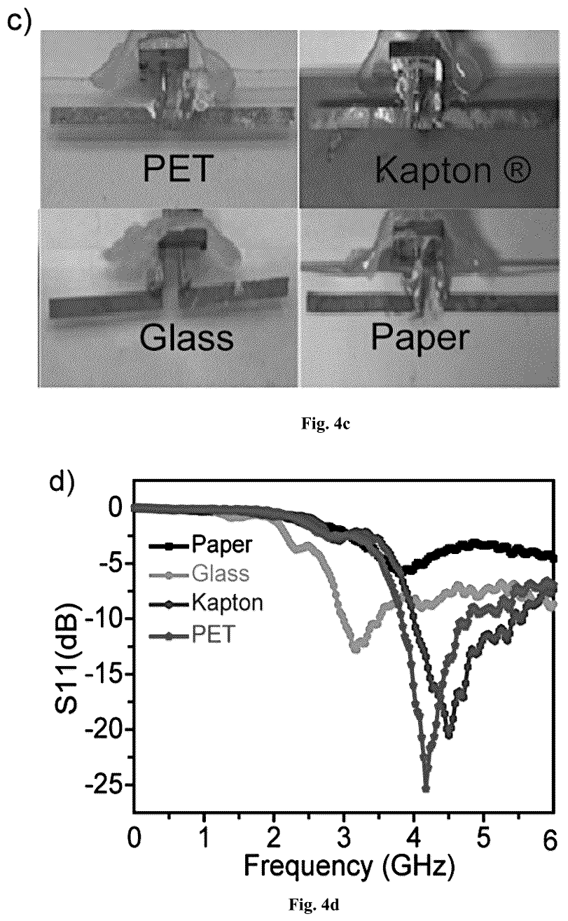

Post annealing of the sintered films drastically improves the conductivity of the copper films. Free standing copper films were tested for electrical conductivity from room temperature up to 900° C. After an annealing process of 900° C., the conductivity can reach 47 MS/m from an initial room temperature reading at 26 MS/m (FIG. 4a). The inset indicates a cross section of the manufactured ultra-thin film conductor with an approximate thickness of 250 nm. This ultra-thin film electrode has a much denser film as the SEM image within the inset indicates and this contributes to its high electrical conductivity. Samples annealed both at 700 and 800° C. demonstrate a high EMI shielding effectiveness of approximately 68 dB across a 0-13 GHz frequency range. This annealing process effectively improves the crystallinity and surface topography of the copper films leading to reduced electron scattering (FIG. 2d) and a notable improvement in the EMI shielding effectiveness as compared to a non-annealed sample (FIG. 4c). Lower electrical conductivity and surface non-uniformity contribute to the lower EMI shielding properties of un-annealed samples. When considering samples annealed above 700° C. the conductors show the appearance of pinholes in the film. This aspect likely correlates to the higher electrical conductivity values without a drastic improvement in EMI shielding.

Once annealed the ultra-thin film copper films were laser ablated to form a dipole antenna and consequently transferred onto a variety of artificial substrates such as polyethylene terephthalate (PET), Kapton®, glass and paper (FIG. 4c). Its RF performance is further demonstrated in FIG. 4d. The S11 parameters were collected across a frequency range of 0-6 GHz on a dipole antenna transferred on paper, glass, Kapton® and polyethylene terephthalate (PET). The S11 signal of each sample all show similar characteristic peaks, however there is some dissonance in the peak positions across the frequency. The resultant resonant frequency shift can be attributed to the difference in the dielectric constants of the substrate materials which inevitably affect the electromagnetic wavelength that can pass through the substrate. The dielectric constants as reported in literature of PET, Kapton®, glass and paper are 3.5, 3.0-4.0, 4.65-6.00, and 3.6 respectively. Considering these values, a correlation can be seen in that the depicted resonant frequency peak goes from lower to higher in samples with substrates with a higher dielectric constant, glass (4.65-6.00), paper (3.6), PET (3.5) and Kapton® (3.0-4.0) respectively. As such it can be concluded that this is due to the shortening of the electromagnetic wavelength as the dielectric constant increases which effectively produces a lower resonance frequency.

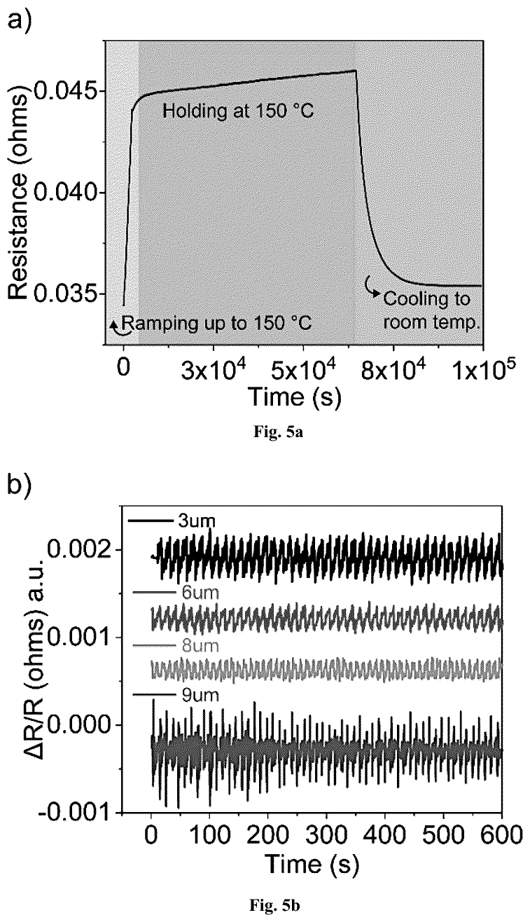

The thermal and mechanical reliability of these printed electrodes are another key factor that impacts the ability of the electrodes to be used as functional RF devices in conformal and long-term applications. FIG. 5a demonstrates a printed Cu conductor held at 150° C. for 12 hours and then cooled. The duration of the test showed a 2.5% change in initial resistance from 0.0344 ohms to 0.0354 ohms. The samples also have high mechanical stability as seen in FIG. 5b which compares the resistance change of samples with widths of 3, 6, 8 and 9 microns. An illustration of the bending apparatus is shown in FIG. 5c. 15 mm long copper films with varied widths were clamped between two plastic plates and a motor driven actuator pushed and pulled the film for approximately 250 bend cycles over 10 minutes—with an average bend radius of 5 mm. This resultant data shows negligible deviation from the initial resistance reading across the samples after the bend cycles. This is likely due to the strong percolation of copper nanoparticles and the formation of a thin film layer that is well adhered to the Kapton® surface. This creates a synergistic effect in which the electrodes can be highly flexible, mechanically stable and maintain a high electrical conductivity.

### Example 6. Conclusions

This work demonstrates the adaptability of a copper precursor-based ink for effective use in the development of highly functional RF devices which can also demonstrate strong mechanical and thermal reliability. Methods for manufacturing an ultra-thin copper conductor successfully demonstrates an improved electromagnetic shielding effectiveness of 68 dB and an electrical conductivity of 47 MS/m. Proven multi-substrate functionality also points to its potential in wearable based electronics.

All publications mentioned herein are incorporated by reference to the extent they support the present invention.

### REFERENCES

A number of patents and publications are cited above in order to more fully describe and disclose the invention and the state of the art to which the invention pertains. Full citations for these references are provided below. Each of these references is incorporated herein by reference in its entirety into the present disclosure, to the same extent as if each individual reference was specifically and individually indicated to be incorporated by reference.
1. Schwierz, F.; Liou, J. J., Semiconductor devices for RF applications: evolution and current status. Microelectronics Reliability 2001, 41 (2), 145-168.
2. Kim, S.; Bito, J.; Jeong, S.; Georgiadis, A.; Tentzeris, M. M. In A flexible hybrid printed RF energy harvester utilizing catalyst-based copper printing technologies for far-field RF energy harvesting applications, 2015 IEEE MTT-S International Microwave Symposium, IEEE: 2015; pp 1-4.
3. Naghdi, S.; Rhee, K. Y.; Hui, D.; Park, S. J., A review of conductive metal nanomaterials as conductive, transparent, and flexible coatings, thin films, and conductive fillers: Different deposition methods and applications. Coatings 2018, 8 (8), 278.
4. Miura, S.; Honma, H., Advanced copper electroplating for application of electronics. Surface and Coatings Technology 2003, 169, 91-95.
5. Sheng, A.; Islam, A.; Khuje, S.; Yu, J.; Tsang, H.; Bujanda, A.; Ren, S., Molecular copper decomposition ink for printable electronics. Chemical Communications 2022, 58 (68), 9484-9487.
6. Dimitriou, E.; Michailidis, N., Printable conductive inks used for the fabrication of electronics: an overview. Nanotechnology 2021, 32 (50), 502009.
7. Tan, H. W.; An, J.; Chua, C. K.; Tran, T., Metallic nanoparticle inks for 3D printing of electronics. Advanced Electronic Materials 2019, 5 (5), 1800831.
8. Li, W.; Sun, Q.; Li, L.; Jiu, J.; Liu, X.-Y.; Kanehara, M.; Minari, T.; Suganuma, K., The rise of conductive copper inks: challenges and perspectives. Applied Materials Today 2020, 18, 100451.
9. Deore, B.; Paquet, C.; Kell, A. J.; Lacelle, T.; Liu, X.; Mozenson, O.; Lopinski, G.; Brzezina, G.; Guo, C.; Lafrenière, S., Formulation of screen-printable Cu molecular ink for conductive/flexible/solderable Cu traces. ACS applied materials & interfaces 2019, 11 (42), 38880-38894.
10. Kamyshny, A.; Magdassi, S., Conductive nanomaterials for 2D and 3D printed flexible electronics. Chemical Society Reviews 2019, 48 (6), 1712-1740.
11. Sheng, A.; Khuje, S.; Yu, J.; Parker, T.; Tsai, J.-Y.; An, L.; Huang, Y.; Li, Z.; Zhuang, C.-G.; Kester, L., Copper Nanoplates for printing flexible high-temperature conductors. ACS Applied Nano Materials 2022, 5 (3), 4028-4037.
12. Habibi, A.; Ketabchi, M., Enhanced properties of nano-grained pure copper by equal channel angular rolling and post-annealing. Materials & Design 2012, 34, 483-487.
13. Henriquez, R.; Flores, M.; Moraga, L.; Kremer, G.; González-Fuentes, C.; Munoz, R. C., Electron scattering at surfaces and grain boundaries in thin Au films. Applied surface science 2013, 273, 315-323.
14. Lacy, F., Developing a theoretical relationship between electrical resistivity, temperature, and film thickness for conductors. Nanoscale research letters 2011, 6, 1-14.
15. Adelabu, M. A.; Imoize, A. L.; Ughegbe, G. U. In Performance evaluation of radio frequency interference measurements from microwave links in dense urban cities, Telecom, MDPI: 2021; pp 328-368.
16. Jang, J.-M.; Lee, H.-S.; Singh, J. K., Electromagnetic shielding performance of different metallic coatings deposited by arc thermal spray process. Materials 2020, 13 (24), 5776.
17. Liu, J.; Yu, M.-Y.; Yu, Z.-Z.; Nicolosi, V., Design and advanced manufacturing of electromagnetic interference shielding materials. Materials Today 2023.
18. Rattanaweeranon, S.; Limsuwan, P.; Thongpool, V.; Piriyawong, V.; Asanithi, P., Influence of bulk graphite density on electrical conductivity. Procedia Engineering 2012, 32, 1100-1106.
19. Hong, J.; Kwon, J.; Im, D.; Ko, J.; Nam, C. Y.; Yang, H. G.; Shin, S. H.; Hong, S. M.; Hwang, S. S.; Yoon, H. G., Best practices for correlating electrical conductivity with broadband EMI shielding in binary filler-based conducting polymer composites. Chemical Engineering Journal 2023, 455, 140528.
20. Tu, H.; Hong, H.; Zhang, Y.; Zhou, L.; Li, X., Influence of Dielectric Loss on RF Performance of Microstrip Multi-Resonant Circuits. Journal of Sensors 2022, 2022.
21. Baker-Jarvis, J.; Kim, S., The interaction of radio-frequency fields with dielectric materials at macroscopic to mesoscopic scales. Journal of research of the National Institute of Standards and Technology 2012, 117, 1.
22. Konieczna, M.; Markiewicz, E.; Jurga, J., Dielectric properties of polyethylene terephthalate/polyphenylene sulfide/barium titanate nanocomposite for application in electronic industry. Polymer Engineering & Science 2010, 50 (8), 1613-1619.
23. Liu, Y.; Zhao, X.-Y.; Sun, Y.-G.; Li, W.-Z.; Zhang, X.-S.; Luan, J., Synthesis and applications of low dielectric polyimide. Resources chemicals and materials 2023, 2 (1), 49-62.
24. Sears, F. W.; Zemansky, M. W.; Walerstein, I., University physics. American Journal of Physics 1950, 18 (8), 530-531.
25. Tipler, P. A.; Mosca, G., Physics for scientists and engineers. Macmillan: 2007.
26. Subramanian, V.; Fréchet, J. M.; Chang, P. C.; Huang, D. C.; Lee, J. B.; Molesa, S. E.; Murphy, A. R.; Redinger, D. R.; Volkman, S. K., Progress toward development of all-printed RFID tags: materials, processes, and devices. Proceedings of the IEEE 2005, 93 (7), 1330-1338.
27. Janeczek, K., Reliability analysis of UHF RFID tags under long-term mechanical cycling.

Microelectronics reliability 2017, 75, 96-101.
28. Arbab, A. A.; Memon, A. A.; Sun, K. C.; Choi, J. Y.; Mengal, N.; Sahito, I. A.; Jeong, S. H., Fabrication of conductive and printable nano carbon ink for wearable electronic and heating fabrics. Journal of colloid and interface science 2019, 539, 95-106.
29. Pidcock, G. C.; in het Panhuis, M., Extrusion printing of flexible electrically conducting carbon nanotube networks. Advanced Functional Materials 2012, 22 (22), 4790-4800.
30. Huang, X.; Leng, T.; Chang, K. H.; Chen, J. C.; Novoselov, K. S.; Hu, Z., Graphene radio frequency and microwave passive components for low cost wearable electronics. 2D Materials 2016, 3 (2), 025021.
31. Bieri, N.; Chung, J.; Haferl, S.; Poulikakos, D.; Grigoropoulos, C., Microstructuring by printing and laser curing of nanoparticle solutions. Applied Physics Letters 2003, 82 (20), 3529-3531.
32. Critchley, K.; Khanal, B. P.; Górzny, M.; Vigderman, L.; Evans, S. D.; Zubarev, E. R.; Kotov, N. A., Near-bulk conductivity of gold nanowires as nanoscale interconnects and the role of atomically smooth interface. 2010.
33. Mo, L.; Liu, D.; Li, W.; Li, L.; Wang, L.; Zhou, X., Effects of dodecylamine and dodecanethiol on the conductive properties of nano-Ag films. Applied Surface Science 2011, 257 (13), 5746-5753.
34. Sharipov, M.; Lee, Y.; Han, J.; Lee, Y.-I., Patterning microporous paper with highly conductive silver nanoparticles via PVP-modified silver-organic complex ink for development of electric valves. Materials Advances 2021, 2 (11), 3579-3588.
35. Gu, W.; Yuan, W.; Zhong, T.; Wu, X.; Zhou, C.; Lin, J.; Cui, Z., Fast near infrared sintering of silver nanoparticle ink and applications for flexible hybrid circuits. RSC advances 2018, 8 (53), 30215-30222.
36. Park, K.; Seo, D.; Lee, J., Conductivity of silver paste prepared from nanoparticles. Colloids and Surfaces A: Physicochemical and Engineering Aspects 2008, 313, 351-354.
37. Chen, J.-J.; Liu, S.-L.; Wu, H.-B.; Sowade, E.; Baumann, R. R.; Wang, Y.; Gu, F.-Q.; Feng, Z.-S., Structural regulation of silver nanowires and their application in flexible electronic thin films. Materials & Design 2018, 154, 266-274.
38. Kumar, A.; Shaikh, M. O.; Chuang, C.-H., Silver nanowire synthesis and strategies for fabricating transparent conducting electrodes. Nanomaterials 2021, 11 (3), 693.
39. Park, B. K.; Kim, D.; Jeong, S.; Moon, J.; Kim, J. S., Direct writing of copper conductive patterns by ink-jet printing. Thin solid films 2007, 515 (19), 7706-7711.
40. Lee, Y.; Choi, J.-r.; Lee, K. J.; Stott, N. E.; Kim, D., Large-scale synthesis of copper nanoparticles by chemically controlled reduction for applications of inkjet-printed electronics. Nanotechnology 2008, 19 (41), 415604.
41. Li, W.; Li, W.; Wei, J.; Tan, J.; Chen, M., Preparation of conductive Cu patterns by directly writing using nano-Cu ink. Materials Chemistry and Physics 2014, 146 (1-2), 82-87.
42. Liu, J.; Ji, H.; Wang, S.; Li, M., The low temperature exothermic sintering of formic acid treated Cu nanoparticles for conductive ink. Journal of Materials Science: Materials in Electronics 2016, 27, 13280-13287.
43. Kramer, R. K.; Boley, J. W.; Stone, H. A.; Weaver, J. C.; Wood, R. J., Effect of microtextured surface topography on the wetting behavior of eutectic gallium-indium alloys. Langmuir 2014, 30 (2), 533-539.
44. Wang, L.; Liu, J., Research advancement of liquid metal printed electronics ink. Imaging Sci. Photochem 2014, 32, 382-392.
45. Nitta, K.; Tsumaki, M.; Kawano, T.; Terashima, K.; Ito, T., Printing PEDOT from EDOT via plasma-assisted inkjet printing. Journal of Physics D: Applied Physics 2019, 52 (31), 315202.
46. Ngamna. O.; Morrin. A.; Killard. A. J.; Moulton, S. E.; Smyth, M. R.; Wallace, G. G . . . . Inkjet printable polyaniline nanoformulations. Langmuir 2007, 23 (16). 8569-8574.

We claim:

1. A metallic MOD ink composition, said composition comprising a transition metal-formate salt in a solvent.

2. The ink composition of claim 1, wherein said transition metal has a reduction potential of about −0.30 V to about +1.20 V.

3. The composition of claim 1, wherein said transition metal is copper, nickel, silver, platinum or palladium.

4. The composition of claim 1, wherein said transition metal is copper.

5. The composition of claim 4, wherein said copper has a net charge of +2.

6. The composition of claim 1, wherein said transition metal-formate salt is copper (II) formate.

7. The composition of claim 1, wherein said ink has a sintering temperature of about 230° C. to about 1100° C.

8. A method of making a metallic MOD ink composition of any of the proceeding embodiments, said method comprising mixing di-ethylene glycol butyl ether (DEGBE) or benzoyl alcohol, dimethylformamide (DMF) or ethylene glycol, and a transition metal-formate salt to form a mixture, wherein said mixture is processed into small particles to make an ink.

9. The method of claim 8, wherein said mixture is processed into small particles by ball milling.

10. The method of claim 9, wherein said mixture is ball milled for about 1 hour.

11. The method of claim 8, wherein said transition metal has a reduction potential of about −0.30 V to about +1.20 V.

12. The method of claim 8, wherein said transition metal is copper, nickel, silver, platinum or palladium,

13. The method of claim 8, wherein said transition metal is copper.

14. The method of claim 13, wherein said copper has a net charge of +2.

15. The method of claim 8, wherein said transition metal-formate salt is copper (II) formate.

16. The method of claim 15, wherein said copper (II) formate, DEGBE, and DMF are mixed in a ratio of about 1:1:0.1 to about 2:1:0.1.

17. A coated material, said material comprising an ink of any of the preceding embodiments disposed on at least a portion of a surface of said material.

18. The material of claim 17, wherein said substrate is metal, glass, fabric, or a combination thereof.
